(19) United States
(12) Patent Application Publication
(10) Pub. No.: US 2008/0288316 A1
(43) Pub. Date: Nov. 20, 2008

(54) System and Method for Passive Event Scheduling Using a Moderating Engine

(76) Inventors: Al Chakra, Cary, NC (US); Patrick O'Sullivan, Dublin (IE); Scan Callanan, Dublin (IE); Gary Denner, Dublin (IE)

Correspondence Address: HAMILTON & TERRILE, LLP;IBM RSW, P.O. BOX 203518, AUSTIN, TX, 78720, US

(21) Appl. No.: 11/749,841

(22) Filed: May 17, 2007

(51) Int. Cl. G06F 9/46

(52) U.S. Cl. 705/8

(57) ABSTRACT

A method, system and program are provided for moderating the automated scheduling of meetings and their respective participants. Input actions are received resulting in the origination of a meeting, which is then assigned a hierarchical prioritization value that is cross referenced to the meeting moderator's hierarchical ranking parameters, which are contextually referenced to a hierarchical directory system. Candidate meeting participants are selected for the meeting and their availability information is retrieved. Comparison operations are then performed against the priority ranking of the meeting, the meeting participant's availability information, and the respective hierarchical ranking parameters of the meeting moderator and candidate meeting participants. Optimum scheduling for the meeting is determined and scheduling conflicts are identified. Conflicting meetings are pre-empted if they have a lower prioritization value or if they were originated by a moderator with lower hierarchical ranking parameters. Affected participants are notified of the preemptions and their reassignment to the newly-originated meeting. The meeting is conducted and meeting status information is communicated by the scheduling moderation system.

### BACKGROUND OF THE INVENTION

1. Field of the Invention

The present invention relates in general to the field of computers and similar technologies, and in particular to software utilized in this field. Still more particularly, it relates to moderating the automated scheduling of meetings and their respective participants.

2. Description of the Related Art

All too often, meetings are a fact of life in an organization. Deciding when they will be scheduled, where they will be held, and who should attend becomes challenging as their number and frequency increases. As a result, there has been a growing reliance on network-based work environments that support software applications such as personal information managers and electronic calendars designed to increase efficiency and productivity. The capabilities of these applications often extend beyond simply managing contacts, maintaining address lists, and task management to provide group management capabilities that enable a meeting moderator to schedule a meeting and assign others to participate. Typically coupled through network-based email communications, invitees can receive assignments to participate in upcoming meetings and signify whether they accept or decline the assignment.

While an invitee's participation may be mandatory or optional, managing the issuance, distribution, tracking, and status of their response to a meeting invitation can present difficulties, especially when scheduling conflicts occur. For example, a project manager may originate a meeting that requires the presence of a representative from each of six departments. While the manager of each department would be the ideal attendee, they may not be available or have scheduling conflicts. Furthermore, it may be difficult to determine whether their scheduling conflict has a greater or lower priority than the proposed meeting. If an invitee fails to participate in a proposed meeting due to a scheduling conflict with a lower priority, then the organization suffers because available resources are not being optimally utilized. Similar issues can arise if a lesser qualified meeting participant is selected as a substitute. In either case, moderation of meeting participant scheduling can become tedious, time consuming and error-prone.

Prior art electronic calendar and scheduling approaches such as Lotus Notes Moderator provided by IBM are able to identify concurrent availability of prospective group of meeting attendees. For example, a send broker and an action broker can be incorporated with a group scheduler and electronic calendar to automatically select invitees to a meeting by applying selection parameters. Invitations to attend the meeting are then generated and sent to invitees who match the selection parameters, who may accept or decline. In response, the system notifies the meeting moderator for updates or modifications to the attendee list, such as selecting alternative invitees if the original invitee cannot attend. However, these systems are neither able to determine the relative priority of conflicting calendar items or take into account the hierarchical ranking of their originator. Furthermore, these systems may not take into account the hierarchical ranking and respective roles of the invitees when automatically selecting meeting participants. As a result, moderation of meeting schedules and determining who is best suited to attend continues to require manual oversight and management by the meeting originator.

### BRIEF SUMMARY OF THE INVENTION

A method, system and program are provided for moderating the automated scheduling of meetings and their respective participants. In various embodiments, input actions are received resulting in the origination of a meeting. In one embodiment, a meeting moderator manually originates the meeting. In another embodiment, the meeting is automatically originated by a project management or other information processing system. Once originated, the meeting is assigned a hierarchical prioritization value by the meeting moderator. In this and other embodiments, the meeting moderator comprises at least one hierarchical ranking parameter that is contextually referenced to a hierarchical directory system. In one embodiment, the hierarchical directory system comprises an electronic directory based on the lightweight directory access protocol (LDAP). Once the meeting moderator assigns a hierarchical prioritization value to the meeting, the prioritization value is cross referenced to the meeting moderator's hierarchical ranking parameters.

Candidate meeting participants are then selected for the newly-originated meeting. In one embodiment, the meeting moderator manually selects the candidate meeting participants, each of which similarly comprises at least one hierarchical ranking parameter. In other embodiments, the candidate meeting participants are automatically selected by the scheduling moderation system based on a plurality of predetermined parameters. Once candidate meeting participants are selected, the constraints of the newly-originated meeting are determined, such as the meeting's date and time scheduling parameters. Candidate meeting participant availability information is then retrieved from their respective electronic calendar systems. Comparison operations are performed against the priority ranking of the meeting, the retrieved meeting participant availability information, and the respective hierarchical ranking parameters of the meeting moderator and candidate participants. Once comparison operations are completed, optimum scheduling within the constraint parameters of the meeting is determined.

Candidate participants with schedule conflicts are identified and if the scheduling conflicts are other meetings, then their respective meeting prioritization value is determined. If their meeting prioritization value is higher, then the hierarchical ranking parameters of their respective originating meeting moderators are determined. Meetings originated by moderators with lower hierarchical ranking parameters are pre-empted. Once pre-empted, the affected meeting participant candidates are notified of the pre-emption of their respective conflicting meetings and their assignment to the newly-originated meeting. In one embodiment, declination of a meeting assignment is escalated to the meeting moderator. In another embodiment, the scheduling moderation system is operable to search for substitute meeting participants. Once meeting constraint parameters have been met, the meeting is conducted and meeting status information is communicated by the scheduling moderation system. In one embodiment, meeting status information is communicated to the newly-originated meeting moderator using electronic communication methods such as email. In other embodiments, meeting status information is electronically communicated to a plurality of information processing systems, such as a project management system.

### BRIEF DESCRIPTION OF THE DRAWINGS

Selected embodiments of the present invention may be understood, and its numerous objects, features and advantages obtained, when the following detailed description is considered in conjunction with the following drawings, in which:

FIG. 1 depicts an exemplary client computer in which the present invention may be implemented;

FIG. 2 shows a simplified block diagram of a scheduling moderation system; and

FIGS. 3a-c show a flow chart of the operation of a scheduling moderation system.

### DETAILED DESCRIPTION

A method, system and program are disclosed for moderating the automated scheduling of meetings and their respective participants. Input actions are received resulting in the origination of a meeting, which is then assigned a hierarchical prioritization value by the meeting moderator. Once assigned, the meeting prioritization value is cross referenced to the meeting moderator's hierarchical ranking parameters, which are contextually referenced to a hierarchical directory system. Candidate meeting participants, each of which similarly comprises at least one hierarchical ranking parameter, are then selected for the meeting. Participant availability information is then retrieved from their respective electronic calendar systems. Comparison operations are performed against the priority ranking of the meeting, the retrieved meeting participant availability information, and the respective hierarchical ranking parameters of the meeting moderator and candidate participants. Once comparison operations are completed, optimum scheduling within the constraint parameters of the meeting is determined. Schedule conflicts are identified, and if they are other meetings, then their respective meeting prioritization value is determined. If their meeting prioritization value is higher, then the hierarchical ranking parameters of their respective originating meeting moderators are determined. Meetings originated by moderators with lower hierarchical ranking parameters are pre-empted. The affected meeting participant candidates are notified of the meeting preemptions and their assignment to the newly-originated meeting. Once meeting constraint parameters have been met, the meeting is conducted and meeting status information is communicated by the scheduling moderation system.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (RF), etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

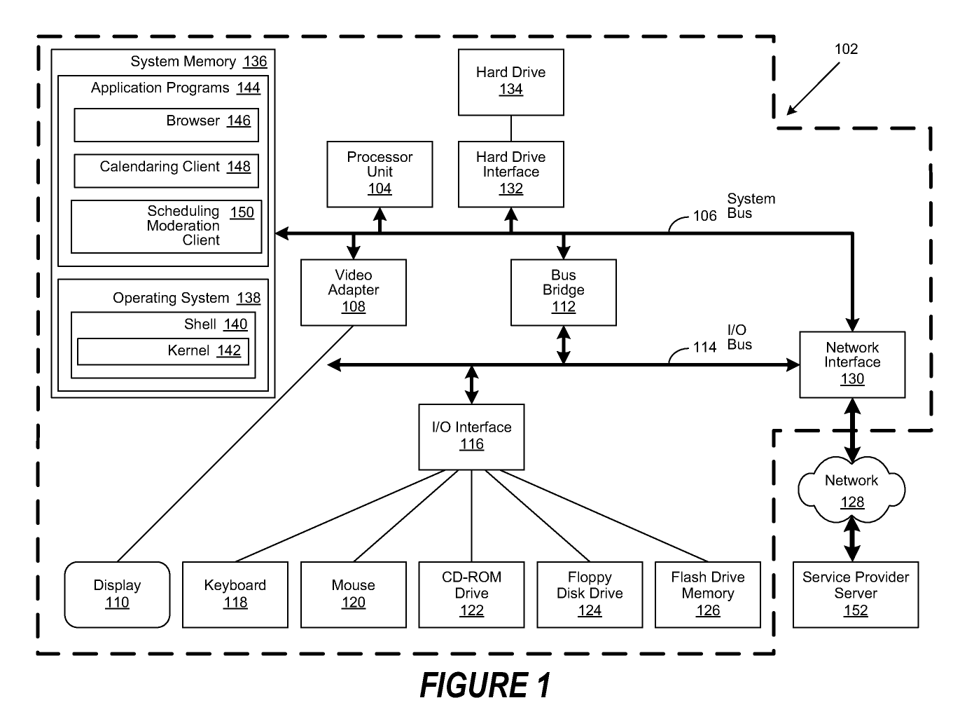

FIG. 1 is a block diagram of an exemplary client computer 102 in which the present invention may be utilized. Client computer 102 includes a processor unit 104 that is coupled to a system bus 106. A video adapter 108, which controls a display 110, is also coupled to system bus 106. System bus 106 is coupled via a bus bridge 112 to an Input/Output (I/O) bus 114. An I/O interface 116 is coupled to I/O bus 114. The I/O interface 116 affords communication with various I/O devices, including a keyboard 118, a mouse 120, a Compact Disk—Read Only Memory (CD-ROM) drive 122, a floppy disk drive 124, and a flash drive memory 126. The format of the ports connected to I/O interface 116 may be any known to those skilled in the art of computer architecture, including but not limited to Universal Serial Bus (USB) ports.

Client computer 102 is able to communicate with a service provider server 152 via a network 128 using a network interface 130, which is coupled to system bus 106. Network 128 may be an external network such as the Internet, or an internal network such as an Ethernet Network or a Virtual Private Network (VPN). Using network 128, client computer 102 is able to use the present invention to access service provider server 152.

A hard drive interface 132 is also coupled to system bus 106. Hard drive interface 132 interfaces with a hard drive 134. In a preferred embodiment, hard drive 134 populates a system memory 136, which is also coupled to system bus 106. Data that populates system memory 136 includes the client computer's 102 operating system (OS) 138 and application programs 144.

OS 138 includes a shell 140 for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. While shell 140 generally is a text-based, line-oriented user interface, the present invention can also support other user interface modes, such as graphical, voice, gestural, etc.

As depicted, OS 138 also includes kernel 142, which includes lower levels of functionality for OS 138, including essential services required by other parts of OS 138 and application programs 144, including memory management, process and task management, disk management, and mouse and keyboard management.

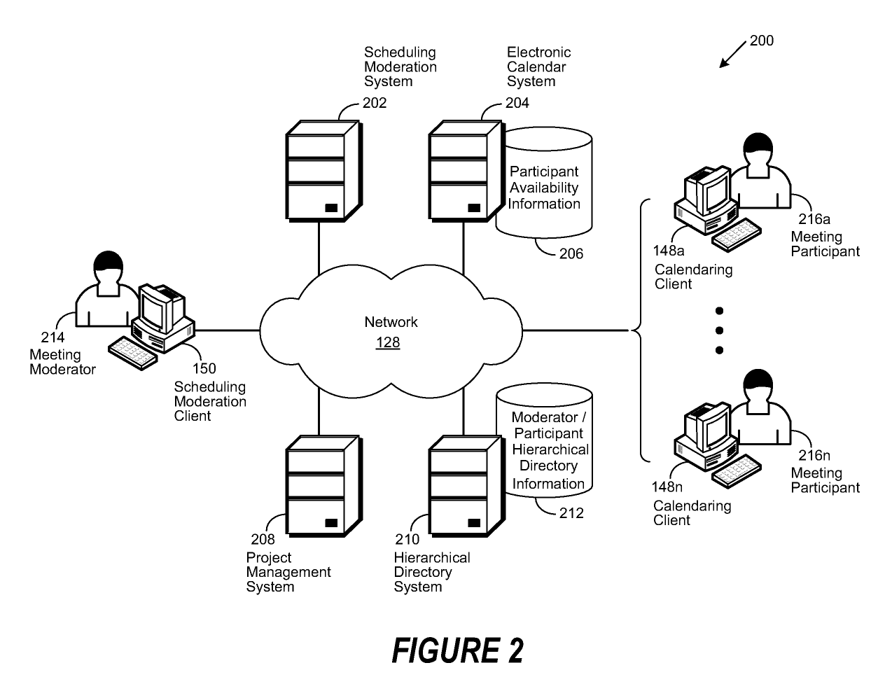

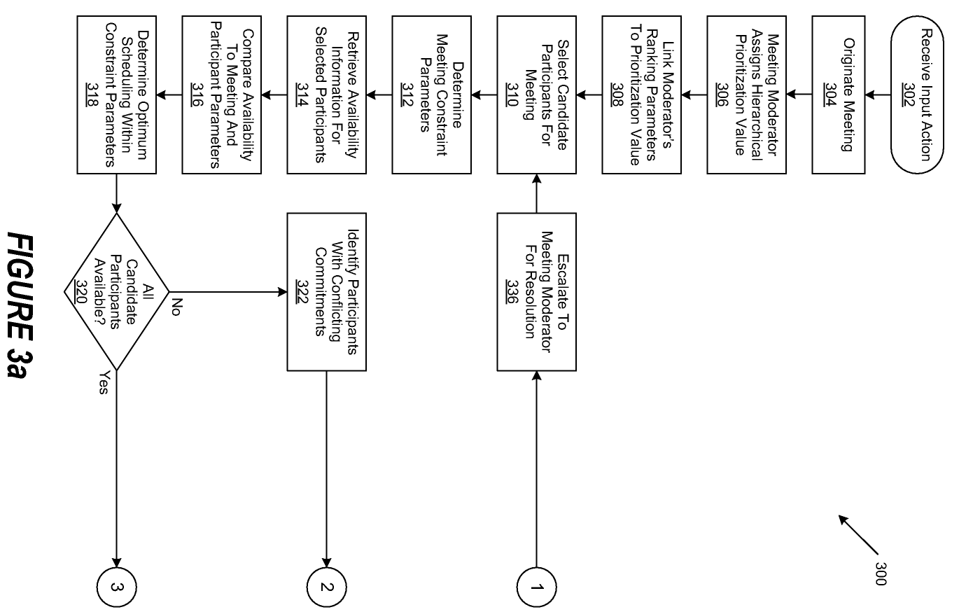

Application programs 144 may include a browser 146 and email client 148. Browser 146 includes program modules and instructions enabling a World Wide Web (WWW) client (i.e., client computer 102) to send and receive network messages to the Internet using HyperText Transfer Protocol (HTTP) messaging, thus enabling communication with service provider server 152. Application programs 144 also include a scheduling moderation client 150. Scheduling moderation client 150 includes code for implementing the processes described in FIG. 2 described hereinbelow. In one embodiment, client computer 102 is able to download scheduling moderation client 150 from a service provider server 152.

The hardware elements depicted in client computer 102 are not intended to be exhaustive, but rather are representative to highlight components used by the present invention. For instance, client computer 102 may include alternate memory storage devices such as magnetic cassettes, Digital Versatile Disks (DVDs), Bernoulli cartridges, and the like. These and other variations are intended to be within the spirit and scope of the present invention.

FIG. 2 shows a simplified block diagram of a scheduling moderation system 200 as implemented in an embodiment of the invention. In various embodiments, input actions are received resulting in the origination of a meeting. In one embodiment, a meeting moderator 214 receives the input action and manually originates the meeting using scheduling moderation client 150 to interact with scheduling moderation system 202 via network 128. In another embodiment, the origination of the meeting is the result of input actions generated by an information processing system such as a project management system 208.

Once originated, the meeting is assigned a hierarchical prioritization value by the meeting moderator 214. In this and other embodiments, the meeting moderator comprises at least one hierarchical ranking parameter that is contextually referenced to a hierarchical directory system 210 comprising moderator and meeting participant hierarchical directory information 212. In selected embodiments, the meeting moderator 214 may comprise a plurality of hierarchical ranking parameters contained in the hierarchical directory information 212. This plurality of hierarchical ranking parameters may include title (e.g., Director of Product Management) and role (e.g., project manager, meeting coordinator, meeting moderator, etc.). In one embodiment, the hierarchical directory system 210 comprises an electronic directory based on the lightweight directory access protocol (LDAP). Once the meeting moderator 214 assigns a hierarchical prioritization value to the meeting, the prioritization value is cross referenced to the meeting moderator's hierarchical ranking parameters in the scheduling moderation system 202.

Candidate meeting participants 216a-n are then selected for the newly-originated meeting. In one embodiment, the meeting moderator 214 manually selects the candidate meeting participants 216a-n, each of which similarly comprises at least one hierarchical ranking parameter contained in the meeting participant hierarchical directory information 212. In other embodiments, the candidate meeting participants 216a-n are automatically selected by the scheduling moderation system 202 based on a plurality of predetermined parameters as described in greater detail herein.

Once candidate meeting participants are selected, the constraints of the newly-originated meeting are determined, such as the meeting's date and time scheduling parameters. Other possible constraints include minimum and optional meeting participant attendance, and which participant's attendance is mandatory. Candidate meeting participant availability information 206 is then retrieved from their respective electronic calendar system 204 by the scheduling moderation system 202. Comparison operations are performed against the priority ranking of the meeting, the retrieved meeting participant availability information 206, and the respective hierarchical ranking parameters 212 of the meeting moderator 214 and candidate participants 216a-n. Once comparison operations are completed, optimum scheduling within the constraint parameters of the meeting is determined.

If it is determined that not all candidate participants are concurrently available, then candidate participants with conflicting schedule commitments are identified. If the scheduling conflicts comprise other meetings, then the scheduling moderation system 202 determines their respective meeting prioritization value. If the conflicting meetings comprise a higher meeting prioritization value, then the scheduling moderation system 202 accesses the hierarchical directory system 210 to determine the hierarchical ranking parameters 212 of their respective originating meeting moderators.

If their respective meeting moderators do not comprise at least one higher hierarchical ranking value 212 than the newly-originated meeting moderator 214, then the conflicting meetings are pre-empted on each candidate meeting participant's 216a-n respective electronic calendar system 204. Once pre-empted, the affected candidate meeting participants 216a-n are notified by the scheduling moderation system 202 of the pre-emption of their respective conflicting meetings and their assignment to the newly-originated meeting via their respective calendaring clients 148a-n. Responses are then received from each candidate meeting participant acknowledging receipt of the newly-originated meeting assignment notification.

In one embodiment, if a candidate meeting participant declines the assignment, the participant's declination is escalated to the moderator 214 of the newly-originated meeting. In another embodiment, the scheduling moderation system 202 is operable to search for substitute meeting participants if the original candidate meeting participant declines the assignment. In this embodiment, the scheduling moderation system 202 retrieves the candidate substitute meeting participants' respective availability, role and hierarchy parameter information as described in greater detail herein. If the candidate substitute meeting participants meet the constraint parameters of the newly-originated meeting, then the optimal candidate is selected and assigned to participate.

Once meeting constraint parameters have been met, the meeting is conducted and meeting status information is communicated by the scheduling moderation system 202. In one embodiment, meeting status information is communicated to the newly-originated meeting moderator 214 using electronic communication methods (e.g., email) familiar to those of skill in the art. In other embodiments, meeting status information is electronically communicated to a plurality of information processing systems, such as project management system 208.

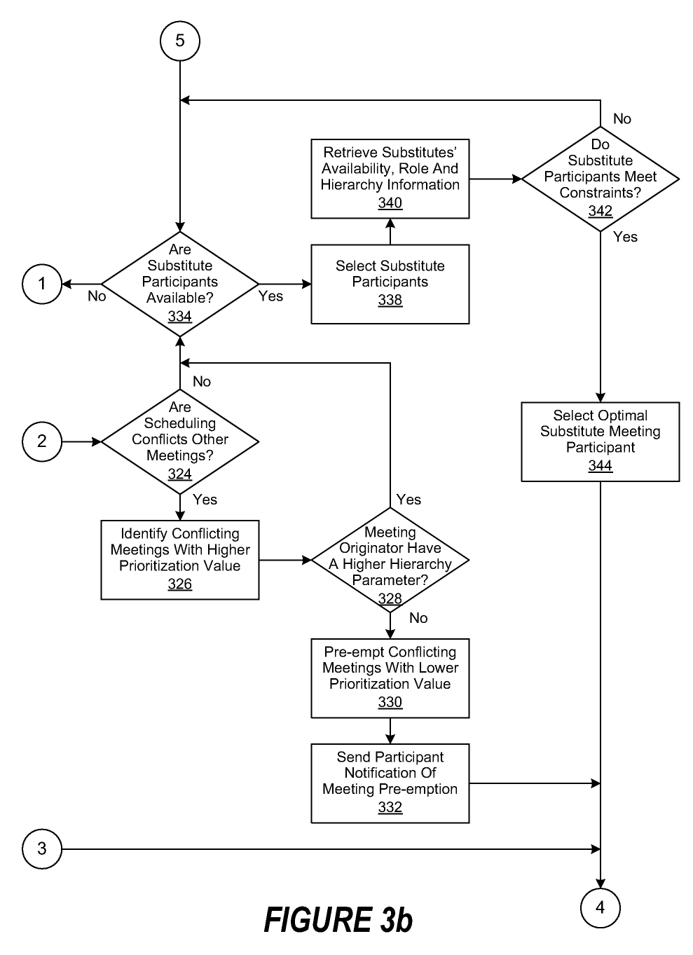

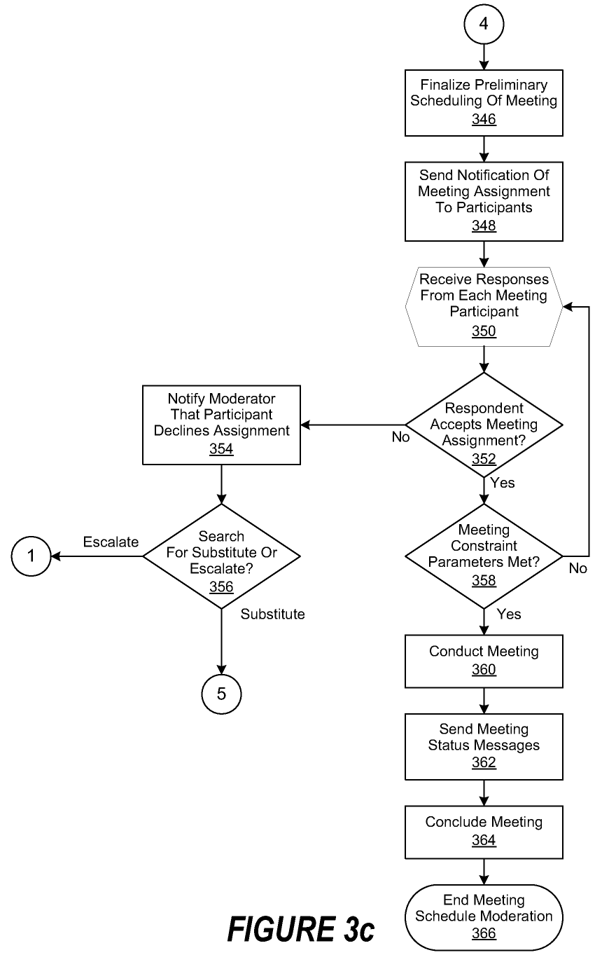

FIGS. 3a-c show a flow chart of a scheduling moderation system 300 implemented in accordance with an embodiment of the invention. In various embodiments, input actions are received in step 302 resulting in the origination of a meeting in step 304. In one embodiment, a meeting moderator receives the input action and manually originates the meeting. In another embodiment, the origination of the meeting is the result of input actions generated by an information processing system such as a project management or workflow application.

Once originated, the meeting is assigned a hierarchical prioritization value in step 306 by the meeting moderator. In this and other embodiments, the meeting moderator comprises at least one hierarchical ranking parameter that is contextually referenced to a hierarchical directory system. In selected embodiments, the meeting moderator may comprise a plurality of hierarchical ranking parameters, such as title (e.g., Director of Product Management) and role (e.g., project manager, meeting coordinator, meeting moderator, etc.). In one embodiment, the hierarchical directory system comprises an electronic directory based on the lightweight directory access protocol (LDAP). Once the meeting moderator assigns a hierarchical prioritization value to the meeting, the prioritization value is cross referenced in step 308 to the meeting moderator's hierarchical ranking parameters in the scheduling moderation system.

Candidate participants for the newly-originated meeting are then selected in step 310. In one embodiment, the meeting moderator manually selects the candidate meeting participants. In other embodiments, the candidate meeting participants are automatically selected by the scheduling moderation system based on a plurality of predetermined parameters. For example, the candidate meeting participants may be selected based on previous involvement or activities (e.g., prior assignment of action items) relating to the originated meeting. As another example, the candidate meeting participants may be selected on their role (e.g., project engineer, quality control, compliance administrator, etc.). In these embodiments, the candidate meeting participants similarly comprise at least one hierarchical ranking parameter that is contextually referenced to a hierarchical directory system.

In step 312, the constraints of the newly-originated meeting are determined, such as the meeting's date and time scheduling parameters, minimum and optional participant attendance, and which participant's attendance is mandatory. In step 314, candidate meeting participant availability information is retrieved from their respective electronic calendar system by the scheduling moderation system. In step 316, comparison operations are performed against the priority ranking of the meeting, the retrieved meeting participant availability information, and the respective hierarchical ranking parameters of the meeting moderator and candidate participants. Once comparison operations are completed in step 316, optimum scheduling within the constraint parameters of the meeting is determined in step 318.

If it is determined in step 320 that not all candidate participants are concurrently available, then candidate participants with conflicting schedule commitments are identified in step 322. Once identified, it is then determined in step 324 whether the conflicting schedule commitments are with other meetings. If they are, then conflicting meetings comprising a higher meeting prioritization value are identified in step 326 and it is then determined in step 328 whether their respective meeting moderators comprise at least one higher hierarchical ranking value.

Those meetings determined in step 328 to be assigned a higher prioritization value by meeting moderators that do not comprise at least one higher hierarchical ranking value are pre-empted in step 330. Once pre-empted, the affected candidate meeting participants are notified of the pre-emption of their respective conflicting meetings in step 332. The preliminary scheduling of the newly-originated meeting is then finalized in step 346, followed by notifications of assignment to the newly-originated meeting being sent to the candidate meeting participants in step 348. Responses are then received in step 350 from each candidate meeting participant acknowledging receipt of the meeting assignment notification. It is then determined in step 352 whether each of the candidate meeting participants accepts assignment to the newly-originated meeting.

As it is determined in step 352 that a candidate meeting participant does not accept assignment to the newly-originated meeting, the moderator of the newly-originated meeting is notified in step 354. It is then determined in step 356 whether a search will be performed for a substitute meeting participant or whether the declination of the originally assigned meeting participant will require escalation for resolution. If it is determined in step 356 that escalation is required, then the declination of the originally assigned meeting participant is escalated to the moderator of the newly-originated meeting in step 336. The process is then repeated, beginning with step 310.

If it is determined in step 356 that a search will be performed for a substitute meeting participant, then it is determined in step 334 whether substitute meeting participants are available. If it is determined in step 334 that candidate meeting participants are available for substitution, then they are selected in step 338. The candidate substitute meeting participants' respective availability, role and hierarchy parameter information is then retrieved in step 340 as described in greater detail herein. If it is determined in step 342 that the candidate substitute meeting participants meet the constraint parameters of the newly-originated meeting, then the optimal candidate is selected in step 344 and the process continues, beginning with step 346. If it is determined in step 342 that the candidate substitute meeting participants do not meet the constraint parameters of the newly-originated meeting, then the process is repeated, beginning with step 334. If it is determined in step 334 that candidate meeting participants are not available for substitution, then the declination of the originally assigned meeting participant is escalated to the moderator of the newly-originated meeting in step 336. The process is then repeated, beginning with step 310.

As it is determined in step 352 that a candidate meeting participant accepts assignment to the newly-originated meeting, it is then determined in step 358 whether meeting constraint parameters have been met. If not, then the process is repeated, beginning with step 350. If meeting constraint parameters have been met, then the meeting is conducted in step 360 and meeting status information is communicated by the scheduling moderation system in step 362. In one embodiment, meeting status information is communicated to the meeting moderator using electronic communication methods (e.g., email) familiar to those of skill in the art. In other embodiments, meeting status information is electronically communicated to a plurality of information processing systems (e.g., project management and workflow applications). Once the meeting is concluded in step 364, schedule moderation ends in step 366.

However, if it is determined in step 320 that all candidate participants are concurrently available, then the preliminary scheduling of the newly-originated meeting is finalized in step 346, followed by notifications of assignment to the newly-originated meeting being sent to the candidate meeting participants in step 348. Responses are then received in step 350 from each candidate meeting participant acknowledging receipt of the meeting assignment notification. It is then determined in step 352 whether each of the candidate meeting participants accepts assignment to the originated meeting.

As it is determined in step 352 that a candidate meeting participant does not accept assignment to the newly-originated meeting, the moderator of the newly-originated meeting is notified in step 354. It is then determined in step 356 whether a search will be performed for a substitute meeting participant or whether the declination of the originally assigned meeting participant will require escalation for resolution. If it is determined in step 356 that escalation is required, then the declination of the originally assigned meeting participant is escalated to the moderator of the newly-originated meeting in step 336. The process is then repeated, beginning with step 310.

If it is determined in step 356 that a search will be performed for a substitute meeting participant, then it is determined in step 334 whether substitute meeting participants are available. If it is determined in step 334 that candidate meeting participants are available for substitution, then they are selected in step 338. The candidate substitute meeting participants' respective availability, role and hierarchy parameter information is then retrieved in step 340 as described in greater detail herein. If it is determined in step 342 that the candidate substitute meeting participants meet the constraint parameters of the newly-originated meeting, then the optimal candidate is selected in step 344 and the process continues, beginning with step 346. If it is determined in step 342 that the candidate substitute meeting participants do not meet the constraint parameters of the newly-originated meeting, then the process is repeated, beginning with step 334. If it is determined in step 334 that candidate meeting participants are not available for substitution, then the declination of the originally assigned meeting participant is escalated to the moderator of the newly-originated meeting in step 336. The process is then repeated, beginning with step 310.

As it is determined in step 352 that a candidate meeting participant accepts assignment to the newly-originated meeting, it is then determined in step 358 whether meeting constraint parameters have been met. If not, then the process is repeated, beginning with step 350. If it has been determined in step 358 that meeting constraint parameters have been met, then the meeting is conducted in step 360 and meeting status information is communicated by the scheduling moderation system in step 362. In one embodiment, meeting status information is communicated to the meeting moderator using electronic communication methods (e.g., email) familiar to those of skill in the art. In other embodiments, meeting status information is electronically communicated to a plurality of information processing systems (e.g., project management and workflow applications). Once the meeting is concluded in step 364, schedule moderation ends in step 366.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A computer-implementable method for moderating the automated scheduling of meetings, comprising:
enabling originating a meeting, the meeting being assigned a prioritization value by a meeting moderator, the prioritization value comprising a hierarchical ranking parameter contextually referenced to a hierarchical directory system;
enabling selecting of a plurality of meeting participants, each of the plurality of meeting participants having corresponding meeting participant information, the meeting participant information comprising:
a hierarchical ranking parameter contextually referenced to the hierarchical directory system;
a meeting role; and
meeting participant availability information stored on an electronic calendar;
enabling scheduling of the meeting using the meeting participant availability information to determine concurrent availability of the meeting participants, the scheduling being bounded by meeting participant information.

2. The method of claim 1, further comprising:
moderating scheduling conflicts of the meeting participants by preempting a commitment of a meeting participant to participate in conflicting meetings comprising a lower the prioritization value.

3. The method of claim 2, wherein the schedule moderation further comprises
preempting a commitment of a meeting participant to participate in conflicting meetings comprising an equal or higher prioritization value originated by a moderator comprising an equal or lower hierarchical ranking parameter.

4. The method of claim 2, wherein the schedule moderation further comprises
designating a second meeting participant to participate in the meeting in place of a first meeting participant, and wherein:
the first meeting participant is committed to participate in a conflicting meeting comprising an equal or higher prioritization value;
the conflicting meeting is originated by a moderator comprising an equal or higher hierarchical ranking parameter; and
the second meeting participant comprises the meeting role equivalent to the first meeting participant's meeting role.

5. The method of claim 1, wherein the schedule moderation further comprises
generating an electronic invitation to the scheduled meeting, the electronic invitation being delivered to each of the plurality of meeting participants using an electronic communication system and comprising meeting information.

6. The method of claim 5, wherein
the meeting information further comprises information associated with conflicting meetings that were pre-empted to allow the meeting participant to participate in the scheduled meeting.

7. A system comprising:
a processor;
a data bus coupled to the processor; and
a computer-usable medium embodying computer program code, the computer-usable medium being coupled to the data bus, the computer program code moderating the automated scheduling of meetings and comprising instructions executable by the processor and configured for:
enabling originating a meeting, the meeting being assigned a prioritization value by a meeting moderator, the prioritization value comprising a hierarchical ranking parameter contextually referenced to a hierarchical directory system;
enabling selecting of a plurality of meeting participants, each of the plurality of meeting participants having corresponding meeting participant information, the meeting participant information comprising:
a hierarchical ranking parameter contextually referenced to the hierarchical directory system;
a meeting role; and
meeting participant availability information stored on an electronic calendar;
enabling scheduling of the meeting using the meeting participant availability information to determine concurrent availability of the meeting participants, the scheduling being bounded the meeting participant information.

8. The system of claim 7, wherein the computer program code further comprises instructions for:
moderating scheduling conflicts of the meeting participants by preempting a commitment of a meeting participant to participate in conflicting meetings comprising a lower prioritization value.

9. The system of claim 8, wherein the moderating further comprises instructions for
preempting a commitment of a meeting participant to participate in conflicting meetings comprising an equal or higher prioritization value originated by a moderator comprising an equal or lower hierarchical ranking parameter.

10. The system of claim 8, wherein the moderating further comprises instructions for
designating a second meeting participant to participate in the meeting in place of a first meeting participant, and wherein:
the first meeting participant is committed to participate in a conflicting meeting comprising an equal or higher prioritization value;
the conflicting meeting is originated by a moderator comprising an equal or higher hierarchical ranking parameter; and
the second meeting participant comprises a meeting role equivalent to the first meeting participant's meeting role.

11. The system of claim 8, wherein the moderating further comprises instructions for generating an electronic invitation to the scheduled meeting, the electronic invitation being delivered to each of the plurality of meeting participants using an electronic communication system and comprising meeting information.

12. The system of claim 11, wherein
the meeting information further comprises information associated with conflicting meetings that were preempted to allow the meeting participant to participate in the scheduled meeting.

13. A computer-usable medium embodying computer program code, the computer program code comprising computer executable instructions configured for:
enabling originating a meeting, the meeting being assigned a prioritization value by a meeting moderator, the prioritization value comprising a hierarchical ranking parameter contextually referenced to a hierarchical directory system;
enabling selecting of a plurality of meeting participants, each of the plurality of meeting participants having corresponding meeting participant information, the meeting participant information comprising:
a hierarchical ranking parameter contextually referenced to the hierarchical directory system;
a meeting role; and
meeting participant availability information stored on an electronic calendar;
enabling scheduling of the meeting using the meeting participant availability information to determine concurrent availability of the meeting participants, the scheduling being bounded by the meeting participant information.

14. The computer program code of claim 13, further comprising instructions for:
moderating scheduling conflicts of the meeting participants by preempting a commitment of a meeting participant to participate in conflicting meetings comprising a lower prioritization value.

15. The computer program code of claim 13, further comprising instructions for:
preempting a commitment of a meeting participant to participate in conflicting meetings comprising an equal or higher prioritization value originated by a moderator comprising an equal or lower hierarchical ranking parameter.

16. The computer program code of claim 13, further comprising instructions for:
designating a second meeting participant to participate in the meeting in place of a first meeting participant, and wherein:
the first meeting participant is committed to participate in a conflicting meeting comprising an equal or higher the prioritization value;
the conflicting meeting is originated by a moderator comprising an equal or higher the hierarchical ranking parameter; and
the second meeting participant comprises a meeting role equivalent to the first meeting participant's meeting role.

17. The computer program code of claim 13, further comprising instructions for:
generating electronic invitation to the scheduled meeting, the electronic invitation being delivered to the each of the plurality of meeting participants using an electronic communication system and comprising meeting information.

18. The computer program code of claim 17, wherein
the meeting information further comprises information associated with conflicting meetings that were preempted to allow the meeting participant to participate in the scheduled meeting.

19. The computer usable medium of claim 13, wherein the computer executable instructions are deployable to a client computer from a server at a remote location.

20. The computer usable medium of claim 13, wherein the computer executable instructions are provided by a service provider to a customer on an on-demand basis.
